(19) United States
(12) Patent Application Publication
(10) Pub. No.: US 2006/0187057 A1
(43) Pub. Date: Aug. 24, 2006

(54) Radio frequency label module

(76) Inventor: San-Lien Yang, Kaohsiung City (TW)

Correspondence Address: TROXELL LAW OFFICE PLLC, SUITE 1404, 5205 LEESBURG PIKE, FALLS CHURCH, VA, 22041, US

(21) Appl. No.: 11/052,949

(22) Filed: Feb. 9, 2005

(51) Int. Cl. G08B 13/14; B31B 1/60

(52) U.S. Cl. 340/572.8; 340/572.7; 156/60

(57) ABSTRACT

A RadioFrequency Identification module includes a radio frequency chip, an antenna substratum and a glued substratum. The antenna substratum has an antenna positioned thereon, with the radio frequency chip attached therein. The glued substratum has a glue cavity properly bored for dispensing epoxy therein. Then the glued substratum and the antenna substratum are adhered together with adhering glue to become a RadioFrequency Identification module, which is then embedded in a carton or the like as an identifying proof describing the content of the carton.

### BACKGROUND OF THE INVENTION

1. Field of the Invention

This invention relates to a Radio Frequency Identification module, particularly to one provided with a wireless identifying code for embedding it in a carton or the like so as to indicating the detail of the content of the cartons to be identifiable by wireless appliances located at a far distance.

2. Description of the Prior Art

Cartons or the like to be transported generally have an identifying code for indicating the details of its content for passing the customs or receiving center. The identifying code is written in an identifying inlay made of plastic adhered on the cartons. However, if the identifying inlay should be peeled off or damaged by some exterior force, it is impossible to be checked by the computer, and moreover, the space for the identifying code is limited, so if the space is full with numbers, it is not useable, resulting in much inconvenience.

### SUMAMRY OF THE INVENTION

The purpose of the invention is to offer a Radio Frequency Identification module, which is able to be identified by a reader, embedded in a cardboard, cartons or a paper pallet.

The Radio Frequency Identification module includes a radio frequency chip, an antenna substratum, and a glued substratum. The antenna substratum has an antenna fixed thereon, and the radio frequency chip is attached on the antenna. The glued substratum has a cavity hole for epoxy to be dispensed therein, and then is adhered with the antenna substratum with adhesive glue to form t the Radio Frequency Identification module, which is then embedded in a cardboard, carton or a paper pallet to function as an identifying proof for indicating the detail of the content of the carton or the like.

Next, The antenna substratum is a flat piece, with an antenna formed by means of etching or printing, and the radio frequency chip is attached on the antenna by means of bumping or wire bonding. The glued substratum is also a flat piece, having a coating cavity at a proper location, with epoxy dispensed in the coating cavity, and then adhered with the radio frequency substratum with adhesive glue. Then the Radio Frequency Identification module is embedded in a carton, cardboard or paper pallet which can be identified the detail of the content by reader installed at the customs or receiving center.

### BRIEF DESCRIPTION OF DRAWINGS

This invention will be better understood by referring to the accompanying drawings, wherein:

FIG. 1 is a perspective view of the Radio Frequency Identification module in the present invent in;

FIG. 2 is an exploded perspective view of the Radio Frequency Identification module in the present invention;

FIG. 3 is a flowing chart of manufacturing processes of the Radio Frequency Identification module in the present invention;

FIG. 4 is a perspective view of a first example of The Radio Frequency Identification module embedded in a corrugated cardboard in the present invention;

FIG. 5 is a perspective view of a second example of the Radio Frequency Identification module embedded in a paper pallet in the present invention;

FIG. 6 is a perspective view of a third example of the Radio Frequency Identification module embedded in a carton in the present invention.

### DETAILED DESCRIPTION OF THE PREFERRED EMBODIMENT

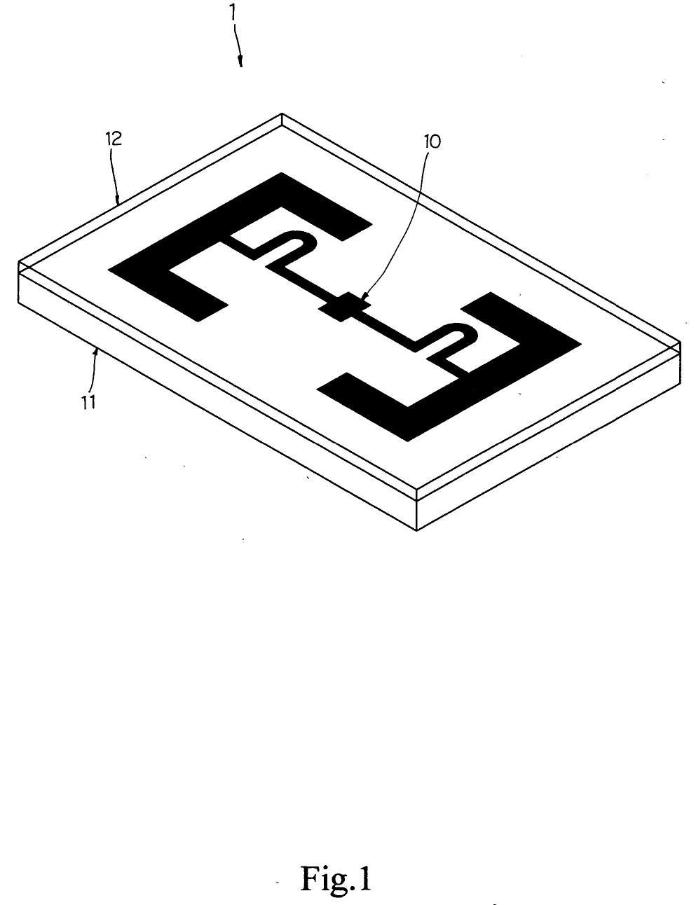

A preferred embodiment of a Radio Frequency Identification module 1 in the present invention, as shown in FIG. 1, includes a radio frequency chip 10, an antenna substratum 11, and a glued substratum 12.

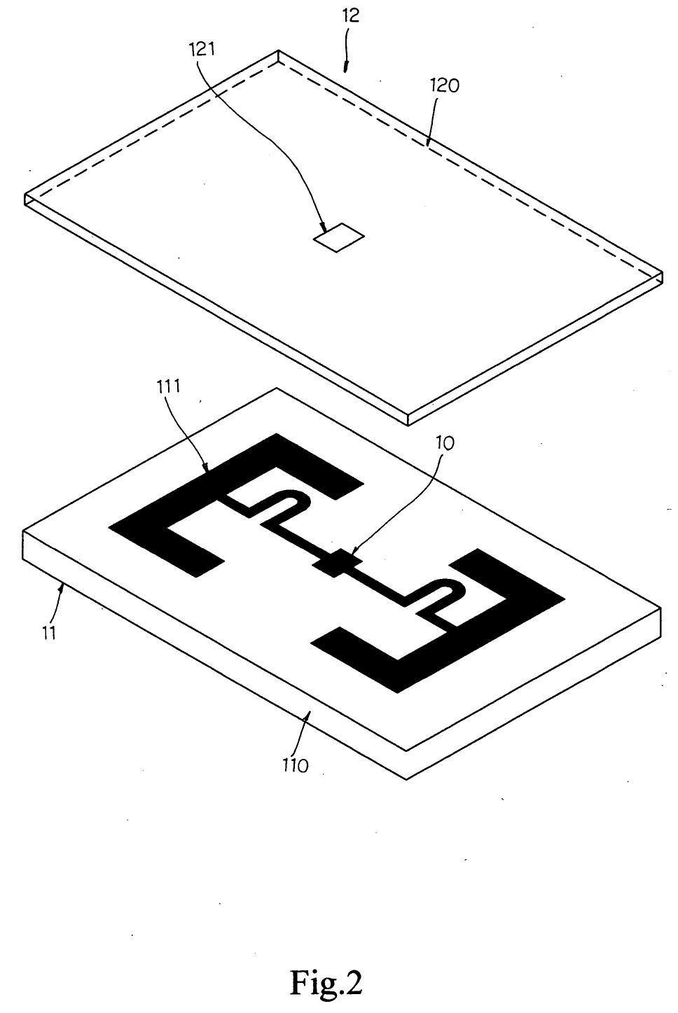

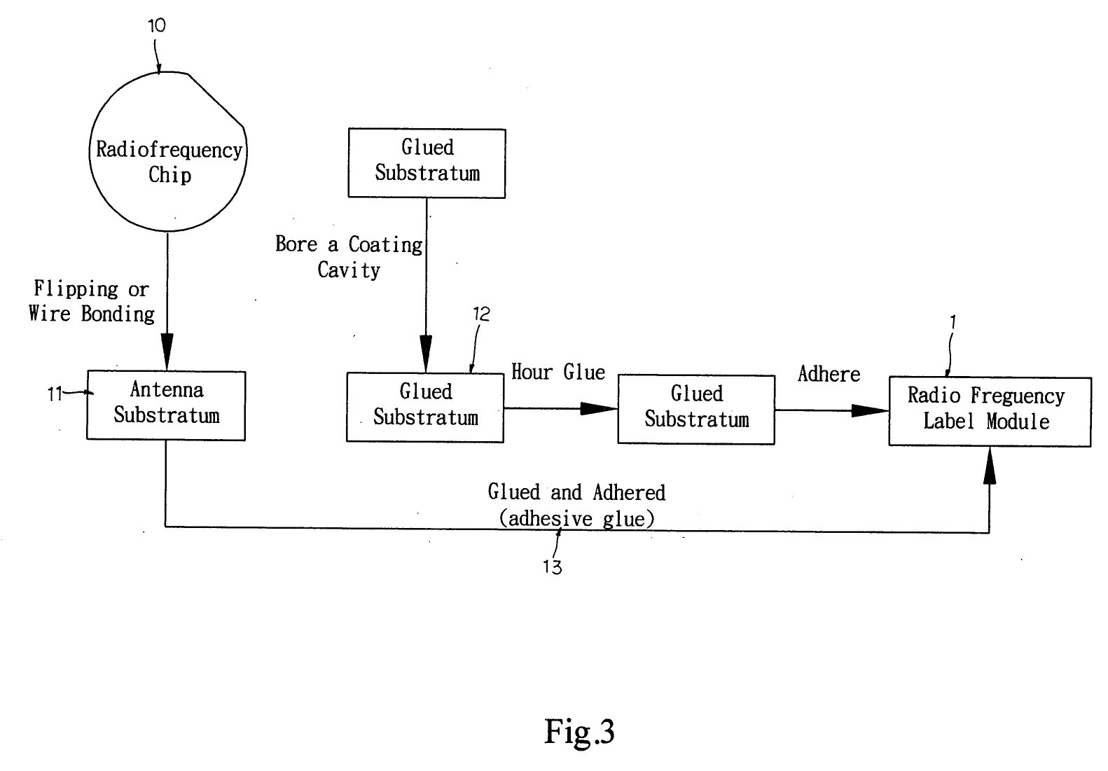

The antenna substratum 11 consists of a substratum 110 made of glass fiber or ceramic, and an antenna 111 formed on the surface of the substratum 110 by means of etching or printing, and the radio frequency chip 10 is attached on the antenna 111 by means of bumping or wire bonding, as shown in FIGS. 2 and 3.

The glue substratum 12 consists of a substratum 120 made of glass fiber or ceramic and a coating cavity 121 formed at a proper location in the substratum 120 and epoxy dispensed in the coating cavity 121.

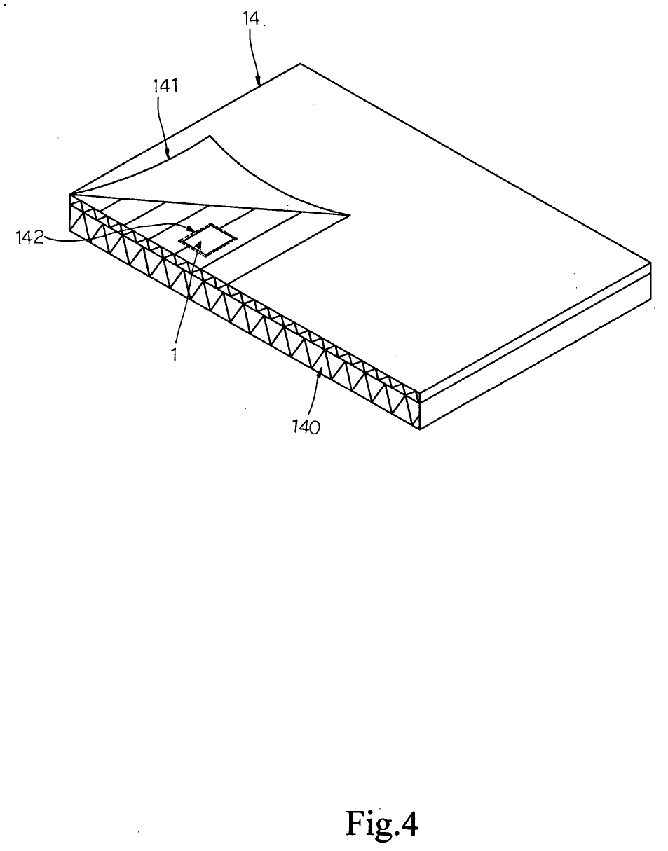

Next, FIG. 4 shows a first example of embedding the radio frequency label module 1 in a corrugated cardboard 14, which is made of a fluting sheet 140 added with liner sheet 141, forming a single face corrugated sheet with a module cavity 142 by means of a flat rolling machine (not shown). Then the radio frequency label module 1 is placed in the module cavity 142 stably, and then the liner paper 141 is adhered on the single face corrugated sheet forming single wall corrugated cardboard, protecting the label module 1 from damaged easily. The process is also applied for manufacturing double or triple wall corrugated cardboard. by corrugator machine.

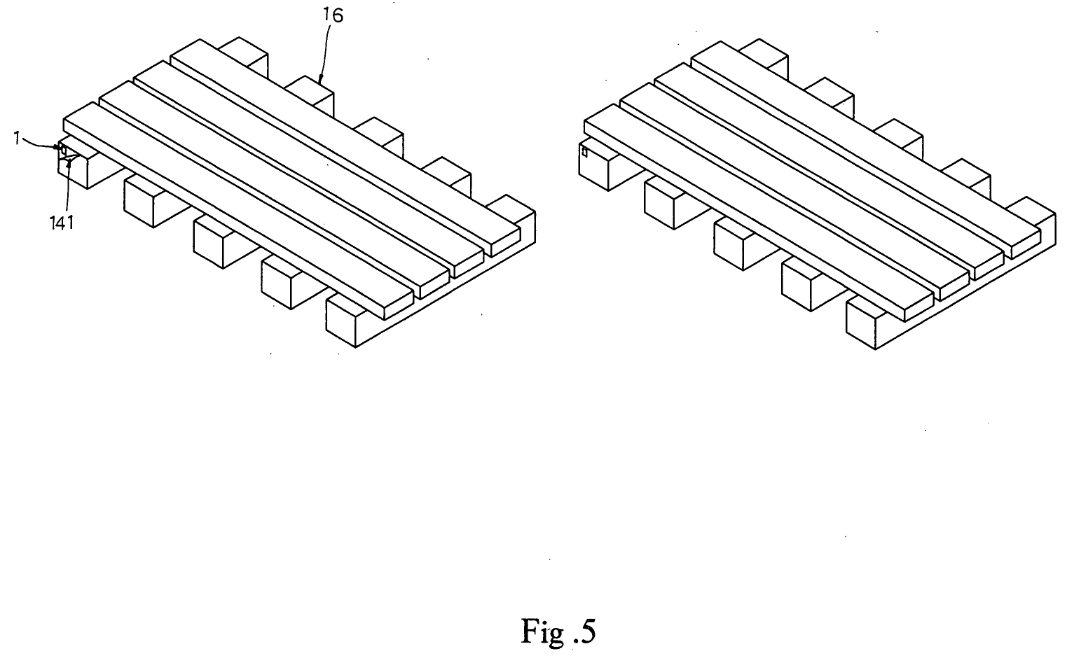

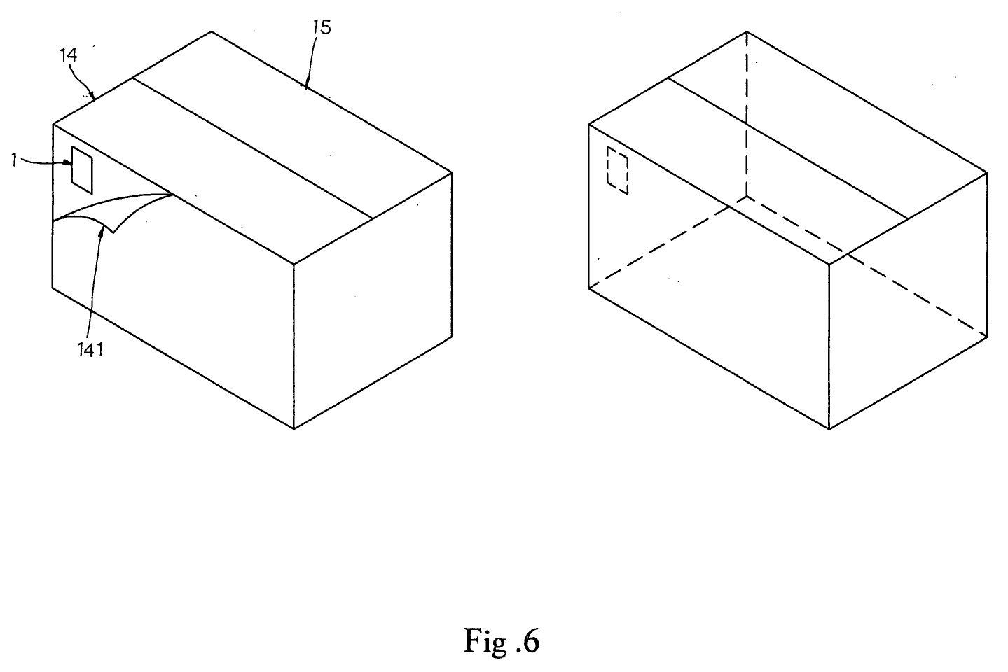

Then the Next, FIG. 5 shows a second example of embedding the radio frequency label module 1 in a carton 15, and FIG. 6 shows a third example of embedding the radio frequency label module in a paper pallet 16 made of cardboard 14.

So the radio frequency label module according to the invention has the following advantages as can be understood from the foresaid description.

1. The Radio Frequency Identification module is hidden in various cardboards, never to get wet, damaged or fall off.

2. The radio frequency chip enables the Radio Frequency Identification module to be not necessarily checked or identified from a short distance, but possible from a rather far distance for convenience.

While the preferred embodiment of the invention has been described above, it will be recognized and understood that various modifications may be made there in and the appended claims are intended to cover all such modifications that may fall within the spirit and scope of the invention.

What is climed is:

1. A Radio Frequency Identification module comprising: A radio frequency chip:
An antenna substratum shaped flat and having an antenna formed on its surface of the substratum, and a radio frequency chip attached on said antenna: and,
A glued substratum shaped flat and having a coating cavity formed in a proper location for epoxy to be dispensed therein, said glued substratum adhered together with said antenna substratum with adhesive glue.

2. The RadioFrequency Identification module as claimed in claim 1, wherein said antenna is formed on said antenna substratum by means of etching.

3. The Radio Frequency Identification module as claimed in claim 1, wherein said antenna 1 is formed on said antenna substratum by means of printing.

4. The Radio Frequency Identification module as claimed in claim 1, wherein said radio frequency chip is attached on said antenna by means of bumping.

5. The Radio Frequency Identification module as claimed in claim 1, wherein said radio frequency chip is attached on said antenna 1 by means of wire bonding.

6. The Radio Frequency Identification module as claimed in claim 1, wherein said substratum is made of glass fiber.

7. The Radio Frequency Identification module as claimed in claim 1, wherein said substratum if made of ceramic.

8. The Radio Frequency Identification module as claimed in claim 1, wherein said Radio Frequency Identification module is embedded in an inner layer of a cardboard.

9. The Radio Frequency Identification module as claimed in claim 1, wherein said radio frequency label module is embedded under the upper surface of a paper pallet
